(19) United States
(12) Patent Application Publication
(10) Pub. No.: US 2014/0068725 A1
(43) Pub. Date: Mar. 6, 2014

(54) Wireless Pairing and Communication Between Devices Using Biometric Data

(71) Applicants: Chang Zhang, San Jose, CA (US); Qing Liu, Mountain View, CA (US)

(72) Inventors: Chang Zhang, San Jose, CA (US); Qing Liu, Mountain View, CA (US)

(73) Assignee: Apple Inc., Cupertino, CA (US)

(21) Appl. No.: 13/601,829

(22) Filed: Aug. 31, 2012

(51) Int. Cl. G06F 21/00

(52) U.S. Cl. 726/5

(57) ABSTRACT

In a first implementation, a host determines to pair with a device and transmits biometric data for a user to the device. The device receives the transmitted biometric data and compares such to device biometric data to determine whether or not to pair with the host and/or what data stored by the device to allow the host to access. The host then accesses data of the device to which the device has allowed access. In another implementation, a device determines to pair with a host and transmits biometric data for a user to the host. The host receives the transmitted biometric data and compares such to device biometric data to determine whether or not to pair with the device and/or what data stored by the host to allow the device to access. The device then accesses data of the host to which the host has allowed access.

### FIELD OF THE INVENTION

This disclosure relates generally to communication between devices, and more specifically to use of biometrics in wireless pairing and communication between devices.

### BACKGROUND

Given the prevalence of electronic devices (such as desktop computers, mobile computing devices, portable data storage devices, smart phones, digital music players, and so on) that store data in the modern world, many users may own and/or utilize more than one such electronic device. As such, users may need to wirelessly transfer data (such as music files, preference files, configuration files, document files, movie files, image files, and so on) back and/or forth between the storage media of various such electronic devices in order to make full use out of the electronic devices. In order to control the use of such electronic devices and/or the security of data stored by such electronic devices, electronic devices may need to perform one or more ‘pairing’ operations before data transfer can be performed. However, in order to provide access control and/or security, such pairing processes may be time consuming and/or otherwise burdensome for users.

For example, electronic devices may be configured to pair and/or communicate data utilizing a Bluetooth® communication connection. However, in order to configure the devices to pair and/or communicate utilizing the Bluetooth® communication connection a user may be required to enter one or more passcodes into one or more of the electronic devices. Such a manual configuration and/or passcodes entry system may be inconvenient for users. Users may not want to remember passcodes and/or have to enter such passcodes or similar security measures in order to transfer data between different electronic devices.

### SUMMARY

The present disclosure discloses systems, methods, and computer program products for wireless pairing and communication between devices using biometrics. In various implementations, a host may determine to pair with at least one device and transmit biometric data for a user of the host to the device. The device may receive the transmitted biometric data. The device may compare such biometric data to biometric data stored in the device to determine whether or not to pair with the host and/or what data stored by the device to allow the host to access. The host may then access data of the device to which the device has allowed access based on the transmitted biometric data.

Similarly, in one or more implementations, a device may determine to pair with at least one host. As such, the device may transmit biometric data for a user of the device to the host. The host may receive the transmitted biometric data and compare such to the host's biometric data. Based on the comparison, the host may determine whether or not to pair with the device and/or what data stored by the host to allow the device to access. The device may then access data of the host to which the host has allowed access based on the transmitted biometric data.

Hosts or devices may pair with devices or hosts (respectively) in order to perform a variety of activities. For example, a device may pair with a host to obtain configuration files in order to configure itself to more closely resemble the configuration of the host, backup files stored by the device on the host, obtain files stored by the host, synchronize files stored on both the device and the host, and so on.

In some implementations, the host or device may simply transmit biometric data. However, in other implementations, the host or device may modify biometric data before transmission, such as by hashing and/or encryption. Such biometric data may include any kind of biometric data, such as fingerprints, handprints, thumb prints, facial images, retinal images, voice signatures, and so on.

In various implementations, the host or device may automatically pair with an available device or host (respectively) as long as the biometric data matches. However, in other implementations, user input indicating to pair (which may include providing of the biometric data) may be required by the host or device requesting the pairing and/or the device or host accepting the pairing.

In one or more implementations, the host or device which allows access to data may simply allow access to any stored data as long as the biometric data matches. However, in other implementations, the host or device may maintain a variety of different permission levels for a variety of different areas of stored data (such as master/owner for secured areas or guest/non-owner for non-secured areas). In such implementations, the host or device may also associate the permission levels with the biometric data. As such, the host or device when paired may only allow access (and/or type of access) corresponding to the permissions associated with the biometric data.

It is to be understood that both the foregoing general description and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

FIG. 1 is a block diagram illustrating a system for wireless pairing and communication between devices using biometrics.

FIG. 2 is a flow chart illustrating a first example method for wireless pairing and communication between devices using biometrics. This method may be performed by the host of FIG. 1.

FIG. 3 is a flow chart illustrating a second example method for wireless pairing and communication between devices using biometrics. This method may be performed by the device of FIG. 1.

FIG. 4 is a flow chart illustrating a third example method for wireless pairing and communication between devices using biometrics. This method may be performed by the device of FIG. 1.

FIG. 5 is a flow chart illustrating a fourth example method for wireless pairing and communication between devices using biometrics. This method may be performed by the host of FIG. 1.

FIG. 6 is a flow chart illustrating a fifth example method for wireless pairing and communication between devices using biometrics. This method may be performed by the host of FIG. 1.

FIG. 7 is a flow chart illustrating a sixth example method for wireless pairing and communication between devices using biometrics. This method may be performed by the device of FIG. 1.

FIG. 8 is a flow chart illustrating a seventh example method for wireless pairing and communication between devices using biometrics. This method may be performed by the host of FIG. 1.

FIG. 9 is a flow chart illustrating an eighth example method for wireless pairing and communication between devices using biometrics. This method may be performed by the device of FIG. 1.

FIG. 10 is a flow chart illustrating a ninth example method for wireless pairing and communication between devices using biometrics. This method may be performed by the host of FIG. 1.

FIG. 11 is a flow chart illustrating a tenth example method for wireless pairing and communication between devices using biometrics. This method may be performed by the device of FIG. 1.

FIG. 12 is a flow chart illustrating an eleventh example method for wireless pairing and communication between devices using biometrics. This method may be performed by the device of FIG. 1.

### DETAILED DESCRIPTION OF THE EMBODIMENTS

The description that follows includes sample systems, methods, and computer program products that embody various elements of the present disclosure. However, it should be understood that the described disclosure may be practiced in a variety of forms in addition to those described herein.

The present disclosure discloses systems, methods, and computer program products for wireless pairing and communication between devices using biometrics. In various implementations, a host (such as a desktop computer, a laptop computer, a smart phone, a cellular phone, a personal digital assistant, a tablet computer, a digital music player, a digital video player, a cloud computing storage server, and/or other such computing device) may determine to pair with at least one device (such as a portable storage device, a desktop computer, a laptop computer, a smart phone, a cellular phone, a personal digital assistant, a tablet computer, a digital music player, a digital video player, a cloud computing storage server, and/or other such device that stores data). As such, the host may transmit biometric data (such as one or more fingerprints, facial images, retinal images, handprints, thumb prints, voice samples, and so on) for a user of the host to the device. The device may receive the transmitted biometric data and compare such to device biometric data to determine whether or not to pair with the host and/or what data stored by the device to allow the host to access. The host may then access data of the device to which the device has allowed access based on the transmitted biometric data.

Similarly, in one or more implementations, a device may determine to pair with at least one host. As such, the device may transmit biometric data for a user of the device to the host. The host may receive the transmitted biometric data and compare such to host biometric data to determine whether or not to pair with the device and/or what data stored by the host to allow the device to access. The device may then access data of the host to which the host has allowed access based on the transmitted biometric data.

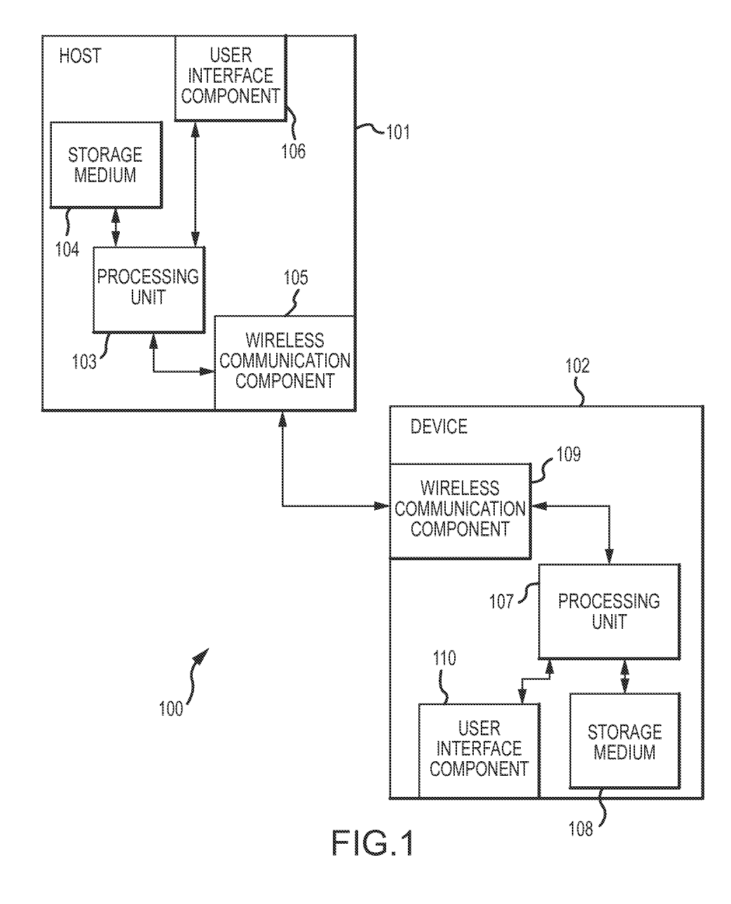

FIG. 1 is a block diagram illustrating a system 100 for wireless pairing and communication between devices using biometrics. The system 100 includes a host 101 and a device 102 that are operable to wirelessly communicate with each other. The host may be a computing device such as a desktop computer, a laptop computer, a smart phone, a cellular phone, a personal digital assistant, a tablet computer, a digital music player, a digital video player, a cloud computing storage server, and/or other such computing device. Additionally, although the host is illustrated and described as a single computing device, in some implementations the host may comprise a plurality of computing devices such as computing devices configured in a cloud computing arrangement. The device may be any electronic device that is operable to store data such as a portable storage device, a desktop computer, a laptop computer, a smart phone, a cellular phone, a personal digital assistant, a tablet computer, a digital music player, a digital video player, a cloud computing storage server, and/or other such device that stores data. Additionally, although the device is illustrated and described as a single device, in some implementations the host may comprise a plurality of devices such as devices configured in a cloud computing arrangement.

The host 101 may include one or more processing units 103, one or more non-transitory storage media 104 (which may take the form of, but is not limited to, a magnetic storage medium; optical storage medium; magneto-optical storage medium; read only memory; random access memory; erasable programmable memory; flash memory; and so on), and/or one or more wireless communication components 105. The host may also include one or more user interface components 106 that are operable to interface with one or more input/output components such as one or more displays, touch screens, keyboards, keypads, touch pads, mice, biometric readers (such as one or more fingerprint readers for capturing one or more fingerprints, thumb prints, palm prints, hand prints and so on; one or more cameras for capturing one or more facial images, retinal images, and so on; one or more microphones for capturing one or more voice signatures and so on; and so on), printers, and/or other such input/output components. The processing unit 103 may execute one or more instructions stored in the non-transitory storage medium 104 to perform one or more host operations such as communicate with the device 102.

Similarly, the device 102 may include one or more processing units 107, one or more non-transitory storage media 108, and/or one or more wireless communication components 109. The device may also include one or more user interface components 110 that are operable to interface with one or more input/output components. The processing unit 107 may execute one or more instructions stored in the non-transitory storage medium 108 to perform one or more device operations such as communicate with the host 102.

In one or more implementations, the host 101 may determine to pair with the device 102. The host may make such a determination based on a variety of different factors such as detection that the device is available for pairing (such as when the host is brought into sufficient proximity to the device, when the host connects to a network through which the device is accessible, and so on), receiving an input from the user indicating to pair with the device (which may be received in response to a prompt indicating that the device is available for pairing), and so on. Upon determining to pair with the device, the host may transmit biometric data for a user of the host to the device. Such biometric data may be stored in the non-transitory medium 104 (and may be associated with one or more logins, accounts, and so on associated with the user currently utilizing the host) and/or may be obtained from the user via the user interface component 106.

When the device 102 receives the biometric data transmitted by the host 101, the device may compare the transmitted biometric data with biometric data stored in the non-transitory storage medium 108 and/or obtained from a user of the device 102 via the user interface component 110. If the comparison results in a match, (and/or receipt of user input indicating to pair with the host), the device may determine to pair with the host and/or allow access to data stored in the non-transitory storage medium 108. In some cases, the data to which the device allows access may be determined based on one or more permissions associated with the biometric data.

After the device 102 allows access, the host 101 may access the data in order to achieve one or more of a variety of different purposes. In various cases, the host may access the data in order to transfer data from the non-transitory storage medium 108 to the non-transitory storage medium 104 (such as to obtain one or more files for the host, synch one or more files of the host with one or more files of the device, and so on), obtain one or more configuration or preference files which may be utilized to configure the host, alter data stored in the non-transitory storage medium 108, transfer data from the non-transitory storage medium 104 to the non-transitory storage medium 108, and so on.

In various implementations, the device 102 may maintain areas of storage in the storage medium 108 of differing security levels. For example, the storage medium 108 may include a public (or unsecured) storage area and a private (or secured) storage area. In this example, the device may allow the host 101 access to the public storage area as long as the host has been allowed to pair with the device. However, the device may not allow a paired host to access the private storage area unless the biometric data received from the host is associated with sufficient permissions on the device. For example, the device may include master (or device owner) level permissions and guest (or non-owner) level permissions. The device may allow a paired host to access the private storage area if the biometric data received from the host is associated with master level permissions. However, if the biometric data received from the host is associated with guest level permissions then the device may only allow the paired host to access the public storage area.

In one or more implementations, the host 101 may transmit the biometric data to the device 102 without modifying the biometric data. However, in other implementations the host may modify the biometric data before transmission. For example, instead of transmitting the biometric data in its entirety, the host may generate a hash value from the biometric data and/or encrypt the biometric data before transmission and the device may compare the hashed and/or encrypted biometric data with a hashed and/or version of biometric data stored by the device. In this way user biometric data may be protected, communication connection bandwidth usage may be minimized, and so on.

In some implementations, after the host 101 and device 102 have paired they may remain paired unless wireless communication between the host and device are interrupted. However, in other implementations either the host or the device may un-pair if a timeout period (such as two minutes) elapses since the last communication between the host and device (such as the last time the host accessed data of the device). In such cases, the user may be able to extend the timeout period, such as by responding to a presented prompt that the timeout period is about to elapse. Yet another implementation would be to have a longer timeout period and allow the user to shorten the timeout period by requesting to terminate the connection via the user interface 106 of the host and/or the user interface 110 of the device.

When the host 101 and device 102 have paired and wireless communication between the host and device is interrupted (such as when the host and device are no longer within sufficient proximity for wireless communication to occur), the host and device may un-pair. In some implementations, when the host and device are again able to communicate wirelessly after un-pairing, the host and device may be required to re-pair before additional wireless communication between the host and device can be performed. However, in other cases the host and device may not be required to re-pair before additional wireless communication between the host and device can be performed. In either case, in some implementations operations that were interrupted by interruption of the wireless communication (such as a partially completed file transfer) may be resumed or restarted.

Although the host 101 and device 102 are described above as storing biometric data and/or receiving biometric data from a user, it is understood that other configurations are possible and contemplated. For example, the device may receive (and/or store) such biometric data from another device, such as the host.

Although system 100 is illustrated and described above in the context of the host pairing with the device and the device allowing device data access to the host, it is understood that this is an example implementation. In other implementations the device may pair with the device and the host may allow host data access to the device based on biometric data. In still other implementations both the host and device may seek to pair with each other and allow data access to each other based on exchanged biometric data.

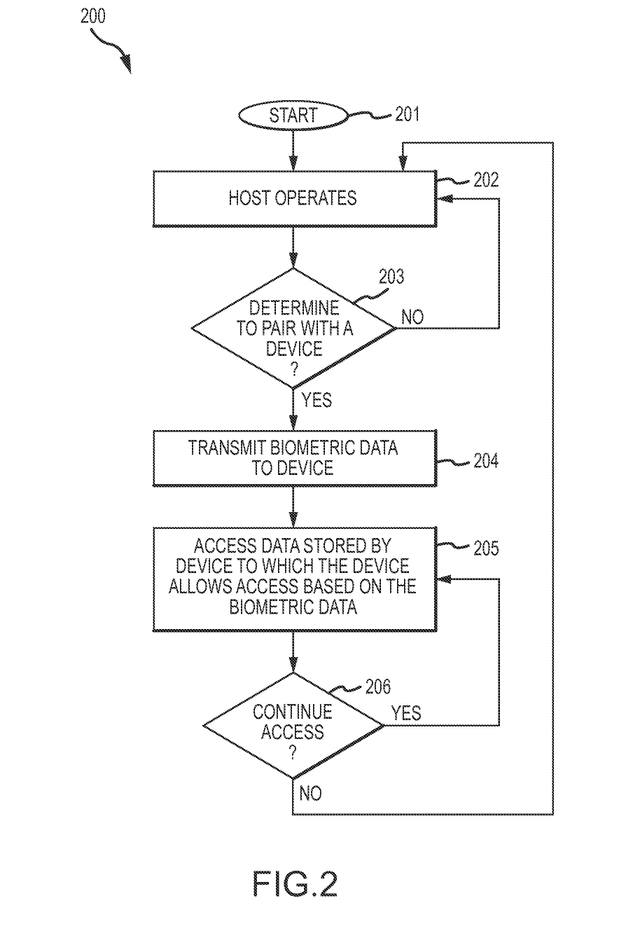

FIG. 2 illustrates a first example method 200 for wireless pairing and communication between devices using biometrics. The method 200 may be performed by the host 101 of FIG. 1. The flow begins at block 201 and proceeds to block 202 where the host operates. The flow then proceeds to block 203 where the host determines whether or not to pair with a device. If so, the flow proceeds to block 204. Otherwise, the flow returns to block 202 where the host continues to operate.

At block 204, after the host 101 determines to pair with a device, the host transmits biometric data to the device. The flow then proceeds to block 205 where the host accesses data stored by the device to which the device allows the host access based on the transmitted biometric data. Then the flow proceeds to block 206.

At block 206, the host 101 determines whether not to continue accessing the data to which the device has allowed access. If so, the flow returns to block 205 where the host continues to access the data. Otherwise, the flow returns to block 202 where the host continues to operate.

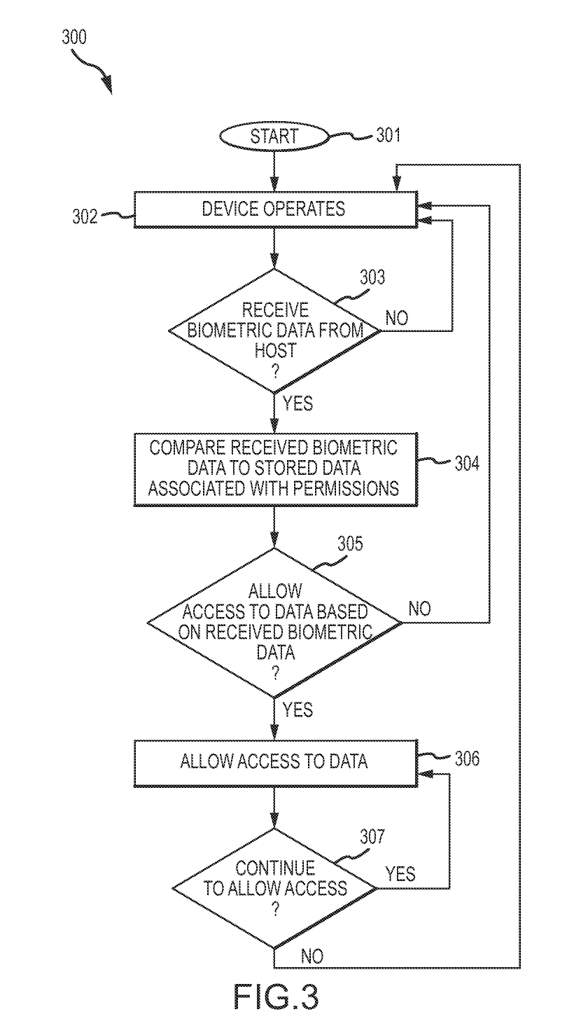

FIG. 3 illustrates a second example method 300 for wireless pairing and communication between devices using biometrics. The method 300 may be performed by the device 102 of FIG. 1. The flow begins at block 301 and proceeds to block 302 where the device operates. The flow then proceeds to block 303 where the device determines whether or not biometric data is received from a host. If so, the flow proceeds to block 304. Otherwise, the flow returns to block 302 where the device continues to operate.

At block 304, after the device 102 has determined that biometric data is received from a host, the device compares the received biometric data to stored biometric data that is associated with permissions regarding the device. The flow then proceeds to block 305 where the device determines whether or not to allow access to data of the device based on the received biometric data. If so, the flow proceeds to block 306. Otherwise, the flow returns to block 302 and the device continues to operate.

At block 306, after the device 102 determines to allow access to data of the device based on the received biometric data, the device allows the host to access the data. The flow then proceeds to block 307.

At block 307 the device 102 determines whether or not to continue to allow the host to access the data. If so, the flow returns to block 306 and the device continues to allow the host to access the data. Otherwise, the flow returns to block 302 and the device continues to operate.

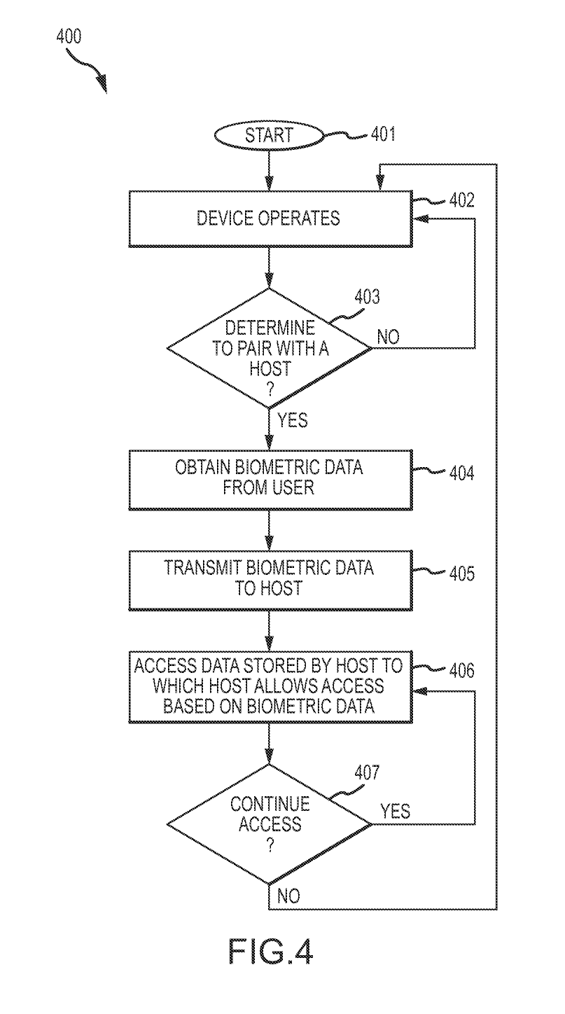

FIG. 4 illustrates a third example method 400 for wireless pairing and communication between devices using biometrics. The method 400 may be performed by the device 102 of FIG. 1. The flow begins at block 401 and proceeds to block 402 where the device operates. The flow then proceeds to block 403 where the device determines whether or not to pair with a host. If so, the flow proceeds to block 404. Otherwise, the flow returns to block 402 where the device continues to operate.

At block 404, after the device 102 determines to pair with a host, the device obtains biometric data for a user via one or more biometric readers. The flow then proceeds to block 405 where the device transmits the obtained biometric data to the host. Next, flow proceeds to block 406 where the device accesses data stored by the host to which the host allows access based on the transmitted biometric data. The flow then proceeds to block 407.

At block 407, the device 102 determines whether or not to continue accessing the data. If so, the flow returns to block 406 where the device continues to access the data to which the host allows access. Otherwise, the flow returns to block 402 where the device continues to operate.

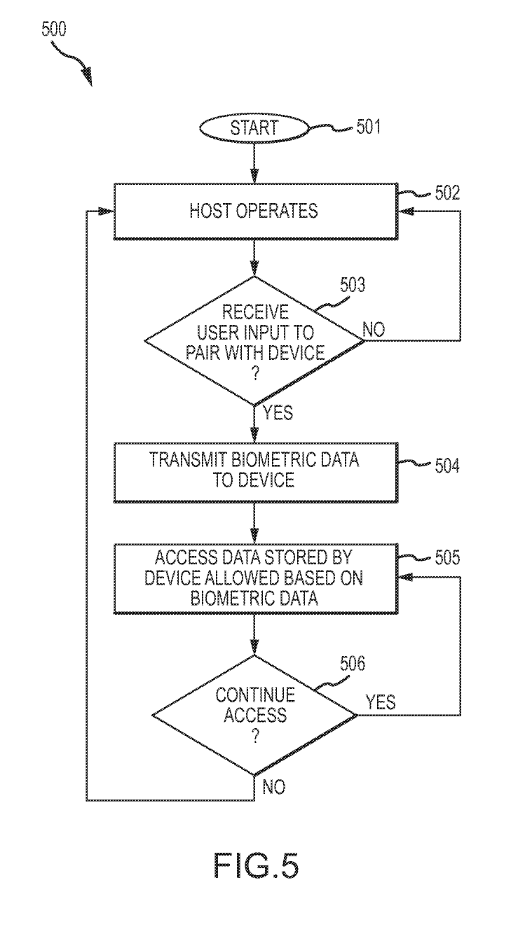

FIG. 5 illustrates a fourth example method 500 for wireless pairing and communication between devices using biometrics. The method 500 may be performed by the host 101 of FIG. 1. The flow begins at block 501 and proceeds to block 502 where the host operates. The flow then proceeds to block 503 where the host determines whether or not user input is received indicating to pair with a device. Such user input may be received in response to a prompt presented by the host indicating that a device is available for pairing. If so, the flow proceeds to block 504. Otherwise, the flow returns to block 502 where the host continues to operate.

At block 504, after the host 101 determines that user input is received indicating to pair with a device, the host transmits biometric data to the device. The flow then proceeds to block 505 where the host accesses data stored by the device to which the device allows access based on the transmitted biometric data. The flow then proceeds to block 506.

At block 506, the host 101 determines whether or not to continue accessing the data. If so, the flow returns to block 505 where the host continues to access the data to which the device allows access. Otherwise, the flow returns to block 502 where the host continues to operate.

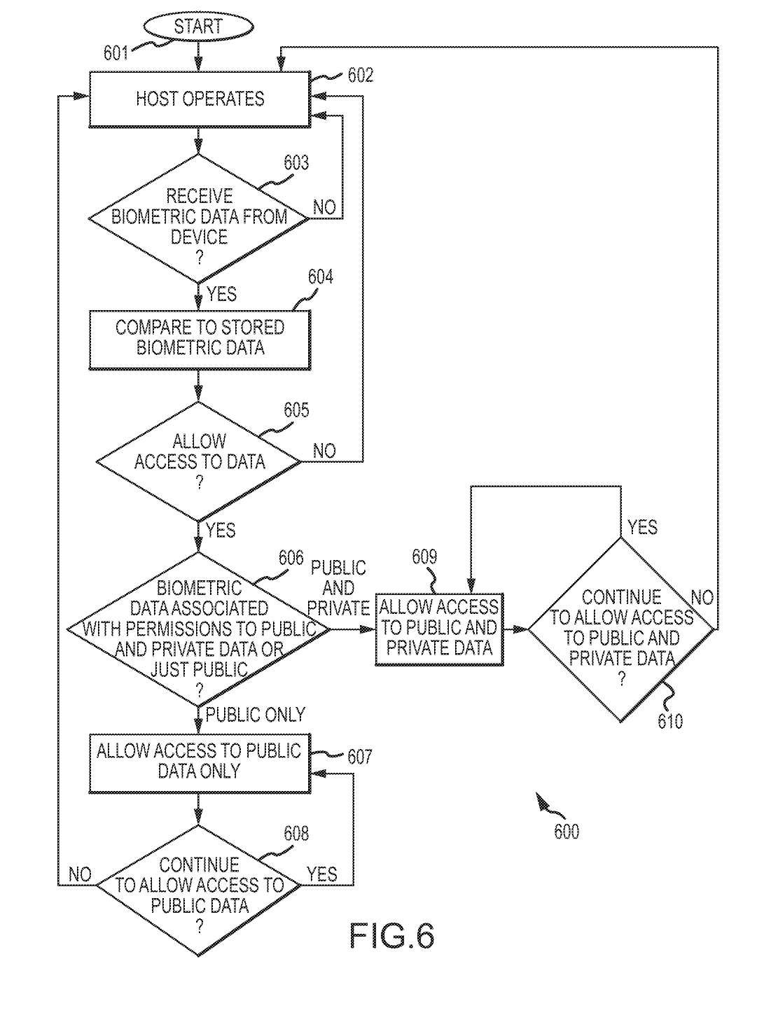

FIG. 6 illustrates a fifth example method 600 for wireless pairing and communication between devices using biometrics. The method 600 may be performed by the host 101 of FIG. 1. The flow begins at block 601 and proceeds to block 602 where the host operates. The flow then proceeds to block 603 where the host determines whether or not biometric data is received from a device. If so, the flow proceeds to block 604. Otherwise, the flow returns to block 602 where the host continues to operate.

At block 604, after the host 101 determines that biometric data from a device is received, the host compares the received biometric data to stored biometric data. The flow then proceeds to block 605 where the host determines whether or not to allow the device access to data of the host based on the comparison. If so, the flow proceeds to block 606. Otherwise, the flow returns to block 602 where the host continues to operate.

At block 606, after the host 101 determines to allow the device access to data of the host, the host determines whether permissions of the host associated with the biometric data are associated with access to at least a public data area of the host (non-secure area) and a private data area of the host (secure area) (master or owner level access) or are associated with access to only the public data area (guest or non-owner level access). If the permissions are associated with access to only the public data area, the flow proceeds to block 607. Otherwise, the flow proceeds to block 609.

At block 607, after the host 101 determines that the permissions are associated with access to only the public data area, the host allows the device to access the public data area. The flow then proceeds to block 608 where the host determines whether or not to continue allowing access to the public data area. If so, the flow returns to block 607 where the host continues to allow the device to access the public data area. Otherwise, the flow returns to block 602 where the host continues to operate.

At block 609, after the host 101 determines that the permissions are associated with access to the public data area and the private data area, the host allows the device to access the public data area and the private data area. The flow then proceeds to block 610 where the host determines whether or not to continue allowing access to the public data area and the private data area. If so, the flow returns to block 609 where the host continues to allow the device to access the public data area and the private data area. Otherwise, the flow returns to block 602 where the host continues to operate.

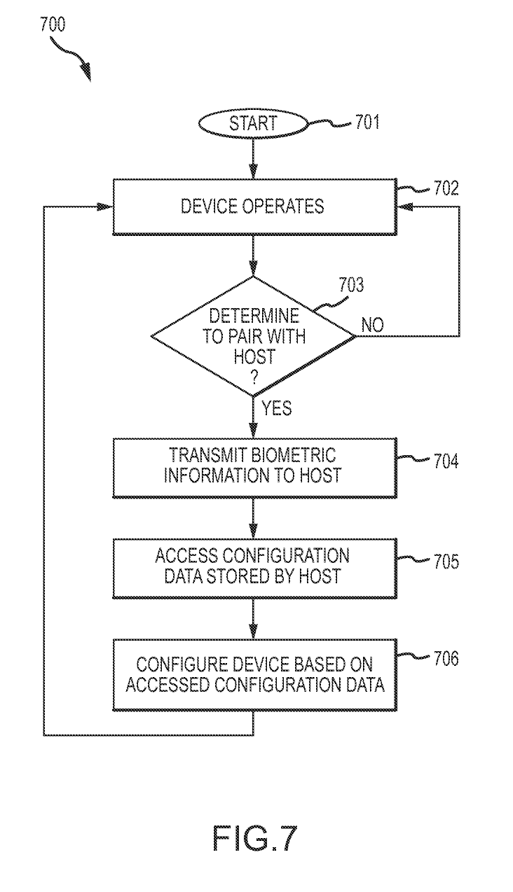

FIG. 7 illustrates a sixth example method 700 for wireless pairing and communication between devices using biometrics. The method 700 may be performed by the device 102 of FIG. 1. The flow begins at block 701 and proceeds to block 702 where the device operates. The flow then proceeds to block 703 where the device determines whether or not to pair with a host. If so, the flow proceeds to block 704. Otherwise, the flow returns to block 702 where the device continues to operate.

At block 704, after the device 102 determines to pair with a host, the device transmits biometric data to the host. The flow then proceeds to block 705 where the device accesses configuration data stored by the host to which the host allows access based on the biometric data. Then the flow proceeds to block 706.

At block 706, the device 102 configures itself based on the accessed configuration data. Such configuration may include setting one or more background images, display settings, sound settings, language settings, alert settings, user preferences, defaults, browser bookmarks, navigation items (such as items included in a ‘dock’), and so on. By configuring itself based on the configuration data obtained from the host, the device may alter itself to more closely resemble the configuration of the host. The flow then returns to block 702 where the device continues to operate.

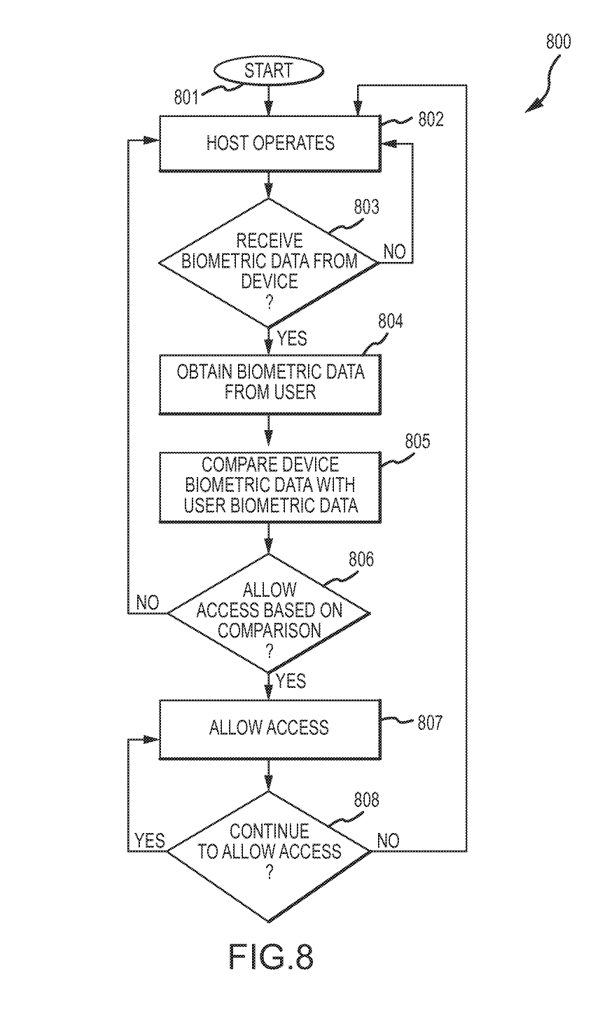

FIG. 8 illustrates a seventh example method 800 for wireless pairing and communication between devices using biometrics. The method 800 may be performed by the host 101 of FIG. 1. The flow begins at block 801 and proceeds to block 802 where the host operates. The flow then proceeds to block 803 where the host determines whether or not biometric data is received from a device. If so, the flow proceeds to block 804. Otherwise, the flow returns to block 802 where the host continues to operate.

At block 804, after the host 101 has determined that biometric data is received from a device, the host obtains biometric data from a user. The flow then proceeds to block 805 where the host compares the biometric data received from the host to the biometric data received from the user. The flow then proceeds to block 806 where the host determines whether or not to allow access to data of the host based on the comparison. If so, the flow proceeds to block 807. Otherwise, the flow returns to block 802 and the host continues to operate.

At block 807, after the host 101 determines to allow access to data of the host based on the comparison, the host allows the device to access the data. The flow then proceeds to block 808.

At block 808, the host 101 determines whether or not to continue to allow the device to access the data. If so, the flow returns to block 807 and the host continues to allow the device to access the data. Otherwise, the flow returns to block 802 and the host continues to operate.

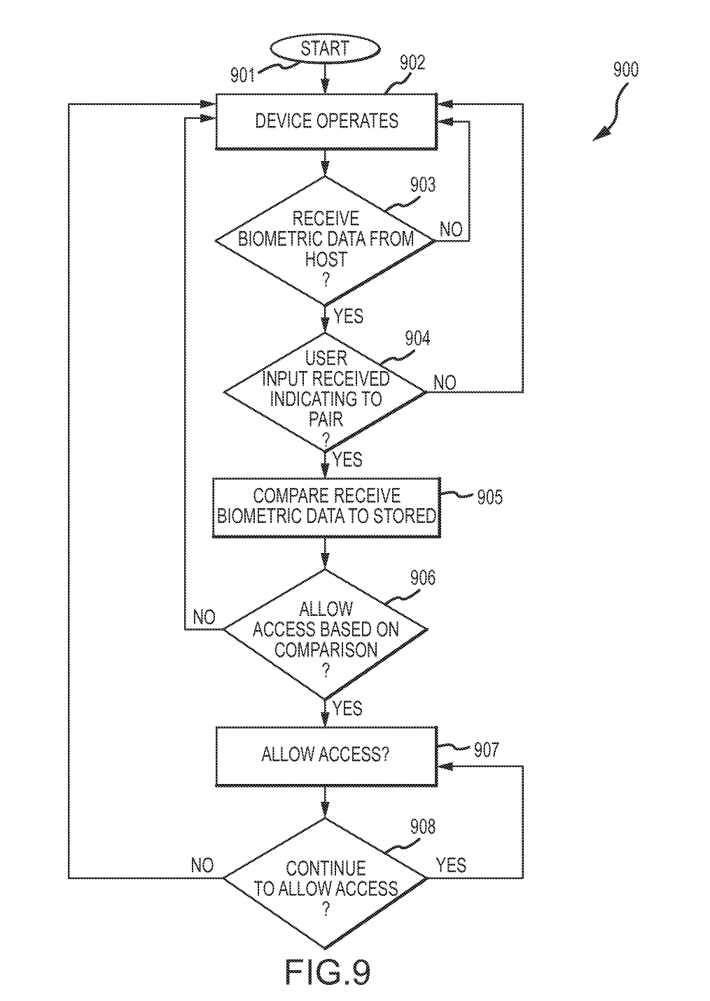

FIG. 9 illustrates an eighth example method 900 for wireless pairing and communication between devices using biometrics. The method 900 may be performed by the device 102 of FIG. 1. The flow begins at block 901 and proceeds to block 902 where the device operates. The flow then proceeds to block 903 where the device determines whether or not biometric data is received from a host. If so, the flow proceeds to block 904. Otherwise, the flow returns to block 902 where the device continues to operate.

At block 904, after the device 102 has determined that biometric data is received from a host, the device determines whether or not user input is received indicating to pair with the host. Such user input may be received in response to a prompt presented by the device indicating that the host is attempting to pair. If the device determines that the user input is received, the flow proceeds to block 905. Otherwise, the flow returns to block 902 where the device continues to operate.

At block 905, the device 102 compares the received biometric data to biometric data stored by the device. The flow then proceeds to block 906 where the device determines whether or not to allow access to data of the device based on the comparison. If so, the flow proceeds to block 907. Otherwise, the flow returns to block 902 and the device continues to operate.

At block 907, after the device 102 determines to allow access to data of the device based on the comparison, the device allows the host to access the data. The flow then proceeds to block 908.

At block 908, the device 102 determines whether or not to continue to allow the host to access the data. If so, the flow returns to block 907 and the device continues to allow the host to access the data. Otherwise, the flow returns to block 902 and the device continues to operate.

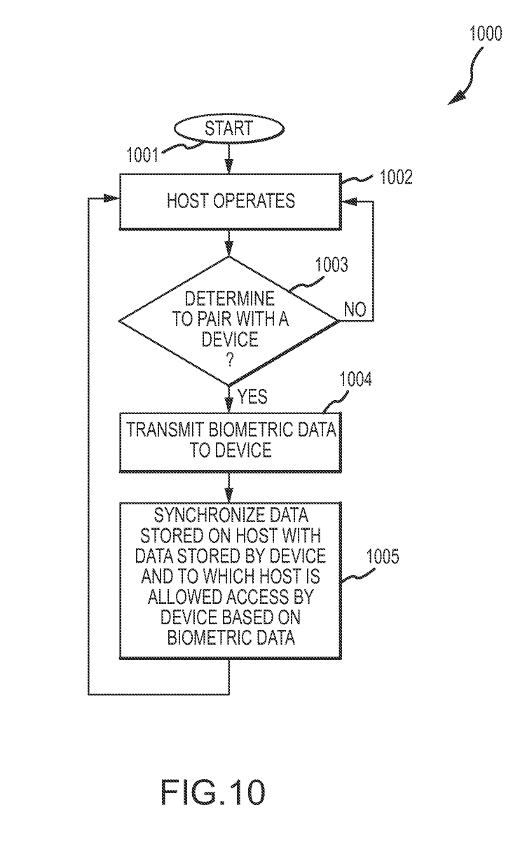

FIG. 10 illustrates a ninth example method 1000 for wireless pairing and communication between devices using biometrics. The method 1000 may be performed by the host 101 of FIG. 1. The flow begins at block 1001 and proceeds to block 1002 where the host operates. The flow then proceeds to block 1003 where the host determines whether or not to pair with a device. If so, the flow proceeds to block 1004. Otherwise, the flow returns to block 1002 where the host continues to operate.

At block 1004, after the host 101 determines to pair with a device, the host transmits biometric data to the device. The flow then proceeds to block 1005 where the host synchronizes data stored on the host with data stored by the device to which the device allows access based on the transmitted biometric data. Such synchronized data may include one or more sets of music files, movies files, document files, spreadsheet files, presentation files, and so on. The flow then returns to block 1002 where the host continues to operate.

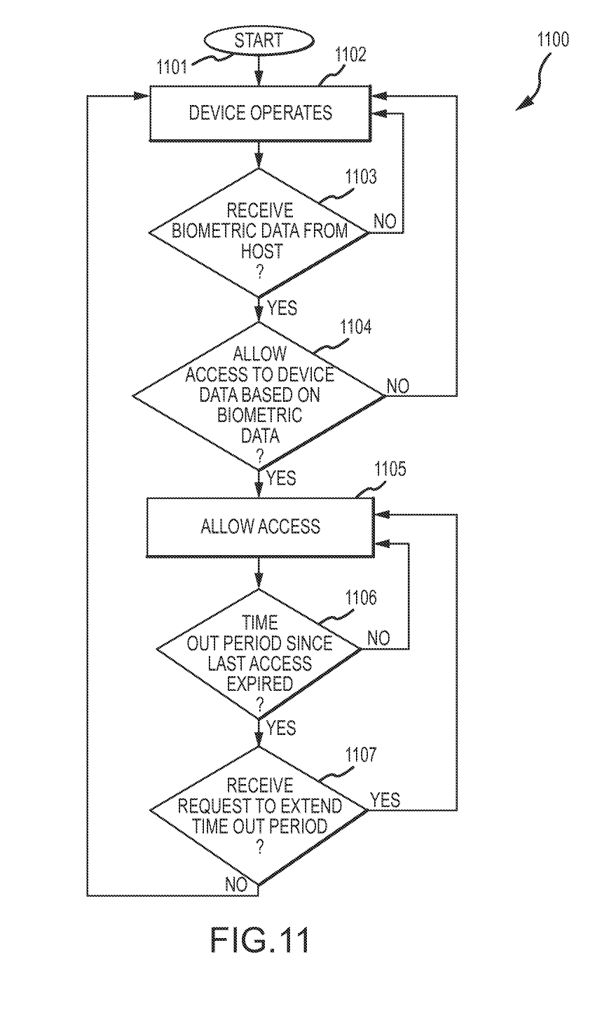

FIG. 11 illustrates a tenth example method 1100 for wireless pairing and communication between devices using biometrics. The method 1100 may be performed by the device 102 of FIG. 1. The flow begins at block 1101 and proceeds to block 1102 where the device operates. The flow then proceeds to block 1103 where the device determines whether or not biometric data is received from a host. If so, the flow proceeds to block 1104. Otherwise, the flow returns to block 1102 where the device continues to operate.

At block 1104, after the device 102 has determined that biometric data is received from a host, the device determines whether or not to allow access to data of the device based on the received biometric data. If so, the flow proceeds to block 1105. Otherwise, the flow returns to block 1102 and the device continues to operate.

At block 1105, after the device 102 determines to allow access to data of the device based on the received biometric data, the device allows the host to access the data. The flow then proceeds to block 1106.

At block 1106 the device 102 determines whether or not a timeout period (such as forty seconds) has expired since the host last accessed the data to which the device allowed access. If so, the flow proceeds to block 1107. Otherwise, the flow returns to block 1105 and the device continues to allow the host access to the data.

At block 1107, after the device 102 determines that the timeout period has expired since the host last accessed the data to which the device allowed access, the device determines whether or not a request to extend the timeout period (such as from a user of the device or a user of the host in response to a presented prompt indicating that the timeout period is about to expire). If so, the device extends the timeout period (such as by a period of time equaling the original timeout period) and the flow proceeds to block 1105 where the device continues to allow the host access to the data. Otherwise, the flow returns to block 1102 and the device continues to operate.

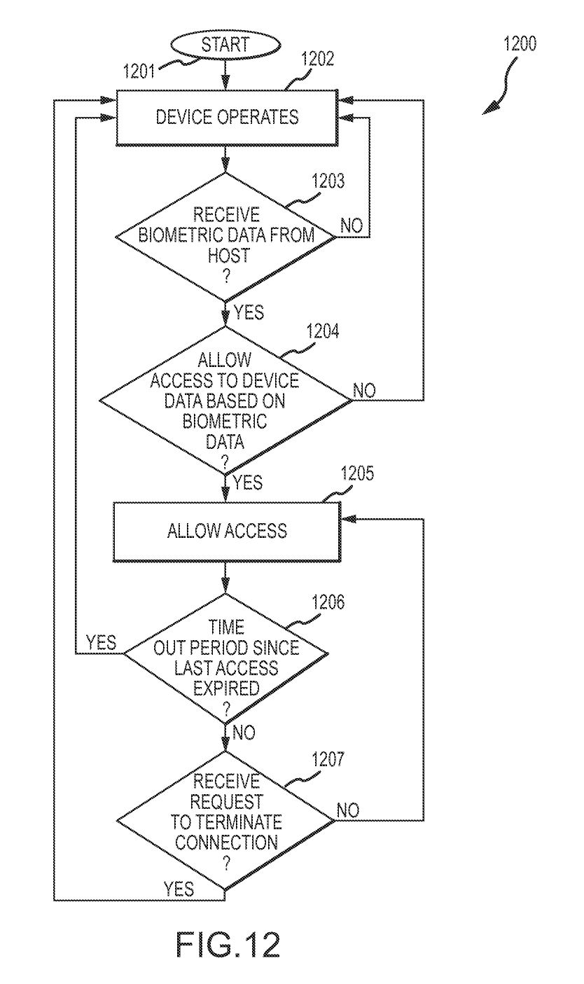

FIG. 12 illustrates an eleventh example method 1200 for wireless pairing and communication between devices using biometrics. The method 1200 may be performed by the device 102 of FIG. 1. The flow begins at block 1201 and proceeds to block 1202 where the device operates. The flow then proceeds to block 1203 where the device determines whether or not biometric data is received from a host. If so, the flow proceeds to block 1204. Otherwise, the flow returns to block 1202 where the device continues to operate.

At block 1204, after the device 102 has determined that biometric data is received from a host, the device determines whether or not to allow access to data of the device based on the received biometric data. If so, the flow proceeds to block 1205. Otherwise, the flow returns to block 1202 and the device continues to operate.

At block 1205, after the device 102 determines to allow access to data of the device based on the received biometric data, the device allows the host to access the data. The flow then proceeds to block 1206.

At block 1206 the device 102 determines whether or not a timeout period (such as forty seconds) has expired since the host last accessed the data to which the device allowed access. If so, the flow returns to block 1202 and the device continues to operate. Otherwise, the flow proceeds to block 1207.

At block 1207, after the device 102 determines that the timeout period has not expired since the host last accessed the data to which the device allowed access, the device determines whether or not a request to terminate the connection between the device and the host has been received (such as from the user). If not, the flow returns to block 1205 and the device continues to allow access. Otherwise, the flow returns to block 1202 and the device continues to operate.

Returning to FIG. 1, in a first example, a user may have a laptop computer and a smart phone. The user may have configured both devices to store the user's biometric data and to automatically pair and synchronize the user's music folder whenever the laptop computer and smart phone are in wireless communication range of each other. As such, when the user moves the smart phone in wireless communication range of the laptop computer, the smart phone may transmit the stored biometric information for the user to the laptop computer. The user may then have full access to the data on both the smart phone and the laptop computer (via the smart phone). Further, the smart phone may be configured to automatically synchronize the user's music folder on the smart phone with the user's music folder on the laptop computer without any user input.

In a second example, a user may wish to share a file on the user's tablet computer with a friend's tablet computer. The user and friend may have configured the two tablet computers to pair when they are in wireless range of each other and the friend may have configured the friend's tablet computer to provide the user read/write access to the friend's tablet computer via the user's tablet computer. As such, when the user moves the user's tablet computer within wireless range of the friend's tablet computer, the user's tablet computer may prompt the user to pair. The user may ‘swipe’ a touch screen of the user's tablet computer to initiate the pairing and then have full access to the data on the user's tablet computer as well as read/write access to the friend's tablet computer. The user may then transfer the file that the user wishes to share from the user's tablet computer to the friend's tablet computer.

In a third example, a user may be borrowing a smart phone from a coworker and may want to obtain a document file from the user's portable storage device. The user's portable storage device may be configured to allow the user access to the user's files from other computers or such devices. As such, when the user moves the coworker's smart phone into wireless range of the user's portable storage device, the coworker's smart phone may prompt the user to pair with the user's portable storage device. The user may ‘swipe’ a touch screen of the coworker's smart phone to initiate the pairing (as well as capture the user's fingerprint to transmit to the user's portable storage device as part of the pairing) and then have full access to the data on the user's portable storage device as well as ‘drop box’ access to the coworker's smart phone. The user may then transfer the document file from the user's portable storage device to a drop box location on the coworker's smart phone via the coworker's smart phone.

In a fourth example, a user may be utilizing a friend's tablet computer and may need to review a presentation file stored on a coworker's computer. The coworker's computer may be configured to allow the user to read and/or write to a non-secure data storage area of the coworker's computer which happens to store the presentation file. The friend's tablet computer may be configured to allow the user ‘drop box’ access to storage of the friend's tablet computer via the friend's tablet computer itself. As such, when the user moves the friend's tablet computer into wireless range of the coworker's computer, the friend's tablet computer and the coworker's computer may both present a prompt to pair. The user may ‘swipe’ a touch screen of the friend's tablet computer and a touch screen of the coworker's computer (which also captures the user's fingerprint to use in the pairing) and then have read/write access to the non-secure data storage area of the coworker's computer as well as ‘drop box’ access to the friend's tablet computer. The user may then transfer the presentation file from the coworker's computer to a drop box area of the friend's tablet computer via the friend's tablet computer.

In a fifth example, a user may be utilizing a borrowed tablet computer and may wish the user interface of the borrowed tablet computer to resemble the user interface of the user's own tablet computer. The user's tablet computer may be configured to allow the user access to the configuration files of the user's tablet computer from other computers. As such, when the user moves the borrowed tablet computer into wireless range of the user's tablet computer, the borrowed tablet computer may prompt the user to pair. The user may ‘swipe’ a touch screen of the borrowed tablet computer to initiate the pairing (as well as capture the user's fingerprint to transmit to the user's tablet computer as part of the pairing). The borrowed tablet computer may obtain the configuration files from the user's tablet computer and then prompt the user to reconfigure the borrowed tablet computer based on the obtained configuration files. Upon receiving confirmation from the user, the borrowed tablet computer may reconfigure itself accordingly.

In a sixth example, a user may have a smart phone and a data storage area in a cloud computing storage system. The user may have configured the smart phone to automatically pair with the cloud computing storage system in order to backup video files stored on the smart phone to a private storage area provided by the cloud computing storage system for the user. As such, whenever the smart phone is connected to the Internet the smart phone may pair with the user's data storage area of the cloud computing storage system and backup the video files stored on the smart phone.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context or particular embodiments. Functionality may be separated or combined in blocks differently in various embodiments of the disclosure or described with different terminology. These and other variations, modifications, additions, and improvements may fall within the scope of the disclosure as defined in the claims that follow.

1. A system for wireless pairing and communication between devices using biometrics, comprising:
at least one host, comprising:
at least one processing unit;
at least one wireless communication component coupled to the at least one processing unit; and
at least one non-transitory storage medium storing instructions executable by the at least one processing unit to:
determine to pair with at least one device;
transmit biometric data to the at least one device utilizing the at least one wireless communication component; and
access data stored by the at least one device that the at least one host is allowed by the at least one device to access based at least one the transmitted biometric data.

2. The system of claim 1, wherein the at least one processing unit accesses data stored by the at least one data device by performing at least one of transferring data from the at least one non-transitory storage medium to the at least one device, transferring data from the at least one device to the at least one non-transitory storage medium, modifying data stored in the at least one device, synchronizing data stored in the at least one non-transitory storage medium with data stored by the at least one device, and configuring the at least one host utilizing configuration data stored by the at least one device.

3. The system of claim 1, wherein the at least one processing unit determines to pair with the at least one device in response to at least one user input.

4. The system of claim 1, wherein the biometric data transmitted by the at least one processing unit is obtained from at least one of the non-transitory storage medium.

5. The system of claim 1, wherein the biometric data transmitted by the at least one processing unit is obtained from a current user of the at least one host.

6. The system of claim 1, wherein at least one of the at least one host and the at least one device comprise at least a portion of a cloud computing storage system.

7. The system of claim 1, wherein the at least one processing unit modifies the biometric data before transmission.

8. The system of claim 7, wherein the modification of the biometric data comprises at least one of hashing the biometric data and encrypting the biometric data.

9. The system of claim 1, wherein the biometric data comprises at least one of at least one fingerprint, at least one thumb print, at least one palm print, at least one handprint, at least one facial image, at least one retinal image, and at least one voice signature.

10. The system of claim 1, wherein the at least one processing unit determines to pair with the at least one device automatically in response to detecting that the at least one device is available for pairing.

11. The system of claim 1, further comprising the at least one device.

12. A system for wireless pairing and communication between devices using biometrics, comprising:
at least one device, comprising:
at least one processing unit;
at least one wireless communication component coupled to the at least one processing unit; and
at least one non-transitory storage medium storing instructions executable by the at least one processing unit to:
receive biometric data from at least one host that has determined to pair with the at least one device utilizing the at least one wireless communication component; and
allow access to the at least one host to data stored by the at least one device based at least one the transmitted biometric data.

13. The system of claim 12, wherein the at least one processing unit allows access to the at least one host if the transmitted biometric data matches biometric data of the at least one device and at least one user input is received by the at least one device indicating for the at least one device to pair with the at least one host.

14. The system of claim 12, wherein the at least one processing unit allows access to the at least one host if the transmitted biometric data matches biometric data stored in the at least one non-transitory medium.

15. The system of claim 14, wherein the biometric data stored in the at least one non-transitory storage medium was received by the at least one device from at least one of the host, a different host, and a different device.

16. The system of claim 12, wherein the at least one processing unit allows access to the at least one host if the transmitted biometric data matches biometric data received from at least one current user of the at least one device.

17. The system of claim 12, wherein the at least one non-transitory storage medium includes at least a first storage area and a second storage area, the at least one processing unit allows the at least one host to access the first storage area but not the second storage area if permissions of the at least one device associated with the transmitted biometric data correspond to a first permission level, and the at least one processing unit allows the at least one host to access the first storage area and the second storage area if permissions of the at least one device associated with the transmitted biometric data correspond to a second permission level.

18. The system of claim 12, wherein the at least one processing unit ceases to allow access to the at least one host if a timeout period expires since the at least one host last accessed the data stored by the at least one device.

19. A method for wireless pairing and communication between devices using biometrics, the method comprising:
determining, utilizing at least one device, to pair with at least one host;
transmitting biometric data from the at least one device to the at least one host utilizing at least one wireless communication component; and
accessing data stored by the at least one host, utilizing the at least one device, that the at least one device is allowed by the at least one host to access based at least one the transmitted biometric data.

20. A method for wireless pairing and communication between devices using biometrics, the method comprising:
receiving biometric data from at least one host that has determined to pair with the at least one device utilizing the at least one wireless communication component; and
allowing the at least one host access to data stored by the at least one device based at least one the transmitted biometric data.
